(19) United States
(12) Patent Application Publication
(10) Pub. No.: US 2024/0004840 A1
(43) Pub. Date: Jan. 4, 2024

(54) AUTOMATIC FILE FORMAT CONVERSION SYSTEM

(71) Applicant: State Farm Mutual Automobile Insurance Company, Bloomington, IL (US)

(72) Inventors: Shrenik Vora, Bloomington, IL (US); Kenneth Albin, Clinton, IL (US); Santhosh Thangavelu, Bloomington, IL (US); Kranthi Poladi, Hyperbad (IN); Sneha Vemula, Normal, IL (US); Sivaraj Bathran, Bloomington, IL (US)

(21) Appl. No.: 18/343,160

(22) Filed: Jun. 28, 2023

Related U.S. Application Data
(60) Provisional application No. 63/356,956, filed on Jun. 29, 2022.

(51) Int. Cl. G06F 16/178; G06F 11/07

(52) U.S. Cl. CPC G06F 16/1794; G06F 11/0775

(57) ABSTRACT

A computer-implemented conversion engine can automatically determine source file formats of a set of source files, and invoke corresponding file converters to convert the source files into output files that are formatted according to the same target file format. If an individual source file is larger than a file size threshold, the conversion engine can divide the source file into smaller component files, separately convert the individual component files into the target file format, and assemble the converted component files into an output file that corresponds to the source file.

### RELATED APPLICATIONS

This U.S. patent application claims priority to provisional U.S. patent application No. 63/356,956, entitled “AUTOMATIC FILE FORMAT CONVERSION SYSTEM,” filed on Jun. 29, 2022, the entirety of which is incorporated herein by reference.

### TECHNICAL FIELD

The present disclosure relates to conversions of data files between different file formats, and more particularly to automatically converting a set of files of one or more file formats into a target file format.

### BACKGROUND

Digital files, such as data files stored on and/or used by computing systems, can be formatted according to a variety of file formats. For example, software applications can be configured to generate and/or save files in many different file formats. In some situations however, it may be desirable to have a set of files that are all formatted according to the same target file format.

For instance, a data analytics team may want to analyze records within a set of files associated with operations of a company to determine performance metrics, sales metrics, and/or other types of metrics. The data analytics team may want to have all of the files in the set of files formatted according to a particular target file format, so that the files can be analyzed together and/or in the same way.

If a set of files includes files that are not formatted according to a desired target file format, file format conversion operations can be performed to convert files into the target file format. However, it can be burdensome and time-consuming for users to manually initiate a file format conversion for each individual file, particularly if the set of files includes a large number of files and/or includes files formatted according to multiple different file formats. For example, users may need to manually identify a file format of each file in the set of files, and download, install, and/or execute different applications to convert each of the files into the desired target file format. Such a manual process may take a significant amount of time, such as hours or days, particularly when the set of files includes files that are formatted according to numerous different file formats.

As an example, an analyst may want to analyze a set of 100,000 files that include similar types of data, but may find that the set of 100,000 files includes files formatted according to numerous different file formats. For instance, different software applications may have generated files within the set of 100,000 files, and the different software applications may have been configured to produce files according to different file formats. The analyst may use analytics tools that are configured to process files that are formatted based on the same file format, such that the analytics tools may not be able to process and evaluate the set of 100,000 files until all of the files are in a common file format. It may take the analyst a significant period of time to manually identify the file format of each of the 100,000 files, determine how to convert each of the 100,000 files into a common file format, and to initiate and complete the conversion process before the analyst can begin analyzing the 100,000 files.

Moreover, some file format conversion operations can fail, or take extended periods of time to complete, if individual files are too large in size. For instance, although a file conversion operation may be initiated in association with a large file, the size of the file may cause the file conversion operation to hang, proceed slowly, consume significant amounts of computing resources, and/or result in errors.

The example systems and methods described herein may be directed toward mitigating or overcoming one or more of the deficiencies described above.

### SUMMARY

Described herein is a conversion engine configured to automatically convert a set of source files in a source directory into corresponding output files, in a destination directory, that are formatted according to the same target file format. Although the source files may be formatted according to one or more file formats, the conversion engine can determine the file formats of each source file. The conversion engine can also automatically invoke different file converters, associated with the corresponding file formats of the source files, to convert the source files into output files that are formatted according to the target file format. Accordingly, by converting the source files into corresponding output files that are all formatted according to the same target file format, the output files can be stored, analyzed, and/or otherwise processed based on the same target file format.

According to a first aspect, a computer-implemented method includes determining, by at least one processor, one or more source file formats of source files in a source directory. The computer-implemented method also includes identifying, by the at least one processor, one or more file converters configured to convert files of the one or more source file formats into a target file format. The computer-implemented method further includes converting, by the at least one processor, and using the one or more file converters, the source files into corresponding output files that are formatted according to the target file format. The computer-implemented method additionally includes storing, by the at least one processor, the corresponding output files in a destination directory.

According to a second aspect, one or more computing devices include at least one processor, and memory storing computer-executable instructions associated with a conversion engine. The computer-executable instructions, when executed by the at least one processor, cause the at least one processor to perform operations. The operations include identifying, based on configuration data, a source directory, a destination directory, and a target file format. The operations also include determining one or more source file formats of source files in the source directory, and identifying one or more file converters configured to convert files of the one or more source file formats into the target file format. The operations further include converting, using the one or more file converters, the source files into corresponding output files formatted according to the target file format. The operations additionally include storing the corresponding output files in the destination directory.

According to a third aspect, one or more non-transitory computer-readable media store computer-executable instructions that, when executed by at least one processor, cause the at least one processor to perform operations. The operations include identifying, based on configuration data, a source directory, a destination directory, and a target file format. The operations also include determining one or more source file formats of source files in the source directory, and identifying one or more file converters configured to convert files of the one or more source file formats into the target file format. The operations further include converting, using the one or more file converters, the source files into corresponding output files formatted according to the target file format. The operations additionally include storing the corresponding output files in the destination directory.

According to a fourth aspect, a computing system includes selection means for selecting source files in a source directory. The computing system also includes identification means for identifying source file formats of the source files. The computing system further includes conversion means for converting the source files from the source file formats into corresponding output files of a target file format. The computing system additionally includes storage means for storing the corresponding output files in a destination directory.

### BRIEF DESCRIPTION OF THE DRAWINGS

The detailed description is set forth with reference to the accompanying FIGURES. In the FIGURES, the left-most digit(s) of a reference number identifies the FIGURE in which the reference number first appears. The use of the same reference numbers in different FIGURES indicates similar or identical items or features.

FIG. 1 shows an example of a conversion engine that is configured to convert source files formatted according to one or more source file formats into corresponding output files formatted according to a target file format.

FIG. 2 shows an example of a conversion of a source file into an output file.

FIG. 3 shows an example in which a source file can be divided, converted, and reassembled into an output file.

FIG. 4 shows a flowchart illustrating an example method for converting source files into output files that are formatted according to a target file format.

FIG. 5 shows an example system architecture for a computing system that can execute the conversion engine.

### DETAILED DESCRIPTION

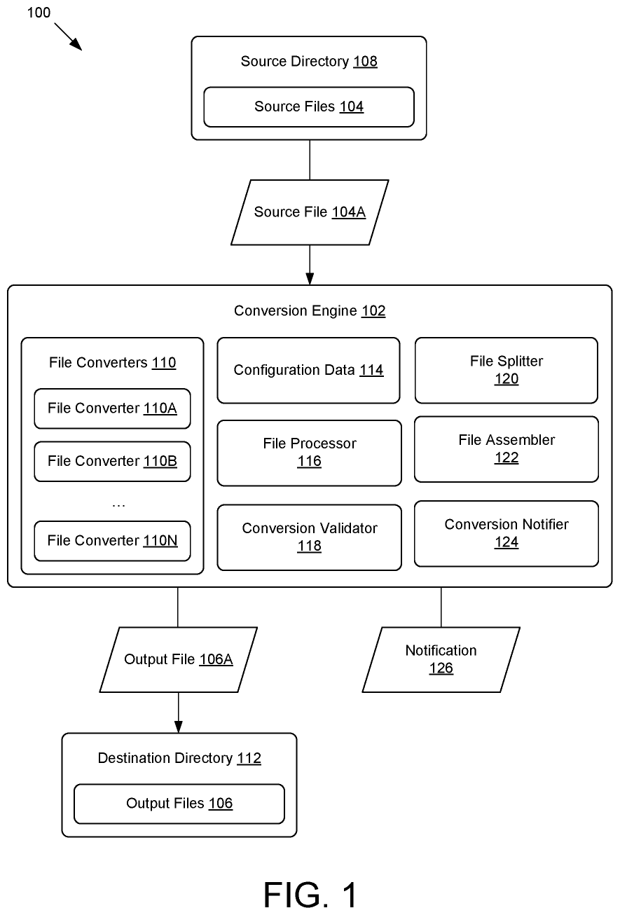

FIG. 1 shows an example 100 of a conversion engine 102 that is configured to convert source files 104 formatted according to one or more source file formats into corresponding output files 106 formatted according to a target file format. The conversion engine 102 can access and/or receive source files 104 from a source directory 108. The conversion engine 102 can use file converters 110, corresponding to the source file formats of the source files 104, to convert the source files 104 into output files 106 that are formatted according to the target file format. The conversion engine 102 can also provide the output files 106 to a destination directory 112, such that the output files 106 can be stored in the destination directory 112. Accordingly, while the source files 104 in the source directory 108 may be formatted according to multiple source file formats, and/or may be formatted according to one or more source file formats that may be different than the target file format, the output files 106 in the destination directory 112 can be consistently formatted according to the target file format.

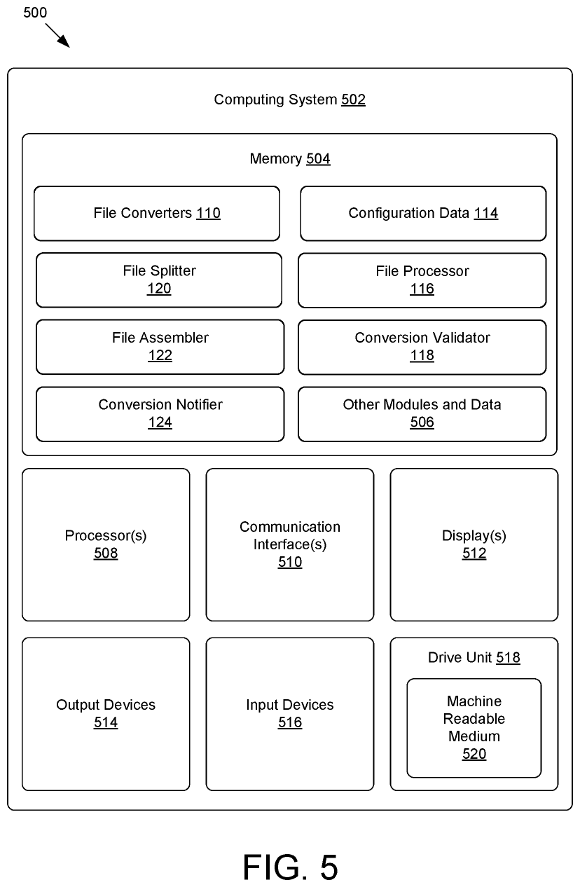

The conversion engine 102 can be a computer-implemented system that is configured to execute via one or more scripts, applications, and/or other elements on one or more computing systems. As a non-limiting example, the conversion engine 102 can execute on a computing system via a shell script and/or a Python script that processes data via a PySpark computing framework. An example of a computing system that can execute the conversion engine 102 is shown in FIG. 5, and described further below with respect to that FIGURE. The conversion engine 102 can be configured to execute on-demand, continuously, periodically, or on any other scheduled or unscheduled basis, such that the conversion engine 102 can automatically convert source files 104 in the source directory 108 into output files 106 formatted according to the target file format.

The computing systems that execute the conversion engine 102 can include a single computing device, multiple computing devices, and/or other computing elements. As an example, the conversion engine 102 may execute locally on one or more computing devices that locally store and/or access the source directory 108 and/or the destination directory 112. As another example, the conversion engine 102 may execute remotely via one or more cloud computing elements, remote servers, and/or one or more other computing elements that can remotely store and/or access the source directory 108 and/or the destination directory 112.

In some examples, the conversion engine 102 can execute via parallel processing via one or more computing systems, for instance to convert different source files 104 at substantially the same time using different threads. Accordingly, if a user wants to convert the set of source files 104 quickly, the user may choose to execute the conversion engine 102 or different instances of the conversion engine 102 via multiple cloud computing servers and/or via multi-threading on a single computing device, such that the conversion engine 102 can convert multiple source files 104 at substantially the same time. However, if a user is less concerned about a timeframe and wants to convert the set of source files 104 at a lower cost and/or using a lower amount of computing resources over a longer period of time, the user can choose to execute the conversion engine 102 via a single thread and/or a single computing device.

In some examples, the conversion engine 102 can execute as a managed service on or within a computing environment managed by an entity, such that the conversion engine 102 can convert files associated with that entity or that are provided to the entity by one or more partners. In other examples, the conversion engine 102 can be provided to one or more partners of the entity, such that the partners can execute one or more instances of the conversion engine 102 in computing environments managed by the partners.

The conversion engine 102 can have configuration data 114 that indicates parameters and/or other information about a file conversion job associated with conversion of the source files 104 into the output files 106. The configuration data 114 can, for instance, indicate the target file format for the output files 106, and an identifier and/or location of the destination directory 112 where the output files 106 are to be stored.

The configuration data 114 can also indicate where the source files 104 can be found and/or accessed by the conversion engine 102. For example, the configuration data 114 can identify the source directory 108 that holds the source files 104. In some examples, the source files 104 can be located in multiple source directories, and the configuration data 114 can identify the multiple source directories. Accordingly, the conversion engine 102 can access and/or retrieve the source files 104 from at least one source directory 108 identified in the configuration data 114.

In some examples, the configuration data 114 may also, or alternately, identify one or more applications that produce the source files 104. For example, the source files 104 may be generated by, and/or added to the source directory 108 by, one or more separate software applications that execute in the same computing environment as the conversion engine 102, or that execute in a different computing environment. Identification of the applications that produce the source files 104 may also directly or indirectly identify one or more source directories where the applications store source files 104 produced by the applications.

The configuration data 114 can also indicate other types of information. For example, the configuration data 114 can indicate whether the source files 104 contain, or are likely to contain, sensitive data, such as Personally Identifiable Information (PII), medical records, or other types of sensitive data. As another example, the configuration data 114 can indicate whether the conversion engine 102 is to validate file conversion operations, maintain logs of errors and/or other data, send notifications to one or more destinations, and/or perform other operations.

As yet another example, the configuration data 114 can indicate a file size threshold. As described further below, if a particular source file within the source directory 108 is larger than the file size threshold indicated by the configuration data 114, the conversion engine 102 can divide the source file into multiple smaller component files that have sizes that are equal to or smaller than the file size threshold. The conversion engine 102 can separately convert the smaller component files into the target file format, and then assemble the converted component files into an output file that is formatted based on the target file format.

In some examples, the configuration data 114 can be a configuration file or other data that is generated by a user via a text editor or other software application, and that is loaded into the conversion engine 102 or to a memory location that is accessible by the conversion engine 102. In other examples, the conversion engine 102 may have a user interface, such as a graphical user interface (GUI), that users can use to provide user input to change settings and adjust the configuration data 114. For instance, the user interface of the conversion engine 102 can allow users to select the target file format, identify the destination directory 112 where output files 106 are to be stored, identify the source directory 108 that stores the source files 104, identify applications that may produce the source files 104, edit a file size threshold, and/or otherwise provide and/or adjust the configuration data. In some examples, the user interface may also allow users to provide user input to initiate a file conversion job based on the configuration data, view status and/or progress information about the file conversion job, view error details and/or other notifications associated with the file conversion job, and/or otherwise interact with the conversion engine 102 before, during, and/or after the file conversion job.

As described above, the source files 104 may be formatted according to one or more file formats. For example, the source files 104 may include fixed-length files and/or variable-length files such as Microsoft® Excel® files, other types of spreadsheet files, comma-separated value (CSV) files, tab-separated value (TSV) files, other types of delimiter-separated value (DSV) files, JavaScript Object Notation (JSON) files, Extensible Markup Language (XML) files, text files, .dat files, .out files, mainframe files, Apache Parquet files, and/or files of other file formats. The file formats of the source files 104 can be considered to be source file formats, which may be different from the target file format into which the source files 104 are to be converted as described herein.

In some examples, a source file can be a delimited file, such a CSV file or a TSV file, that indicates values in one or more fields associated with one or more records or entries. For instance, a source file can store a two-dimensional array or table of data that includes rows that represent individual records, and columns that store values for one or more fields of each record. As another example, a source file can be a JSON file, XML file, or other type of files that stores data associated with records in attribute-value pairs (AVPs), which may include nested AVPs.

As discussed above, the configuration data 114 can indicate a target file format for the output files 106. As a non-limiting example, the target file format can be set to be the Parquet file format. In other examples, the target file format can be set to any other file format, such as the CSV file format, the TSV file format, the JSON file format, the XML file format, or any other file format. The conversion engine 102 can be configured, as described herein, to convert source files 104 formatted according to one or more source file formats into output files 106 that are formatted according to the target file format indicated by the configuration data 114.

Although in some examples, the source files 104 and/or output files 106 can express information associated with records or other entries as described above, in other examples the source files 104 and/or output files 106 can express document data, image data, video data, audio data, and/or any other type of data. For example, the source files 104 can be include image files of one or more image file formats, and the conversion engine 102 can convert the image files into output files 106 that are formatted based on a target image file format.

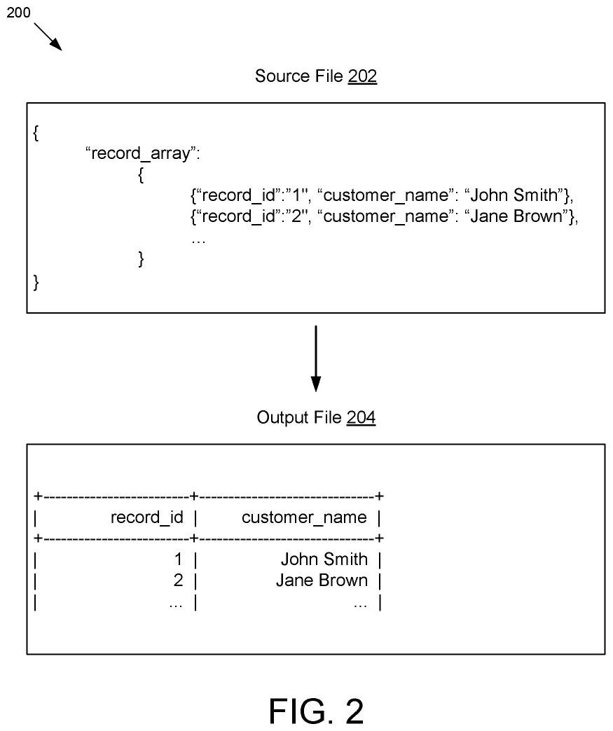

The conversion engine 102 can have, access, and/or use different file converters 110, such as file converter 110A, 110B, . . . 110N (collectively referred to as “file converters 110”) shown in FIG. 1. Different file converters 110 can be configured to convert files formatted according to different file formats into other file formats. The conversion engine 102 can automatically invoke the file converters 110 to convert individual source files 104 formatted according to one or more source file formats into corresponding output files 106 that are formatted according to the target file format. An example of a file converter converting a source file of one file format into an output file of another file format is shown in FIG. 2, and is discussed further below with respect to that FIGURE.

In some examples, the conversion engine 102 can have a first set of file converters 110 that convert files of various file formats into a first file format, and a second set of file converters 110 that convert files of various file formats into a second file format. Accordingly, if the target file format is set as the first file format in the configuration data 114, the conversion engine can use the first set of file converters 110 to convert source files 104 into output files 106 formatted according to the first file format. If the target file format is instead set as the second file format in the configuration data 114, the conversion engine can use the second set of file converters 110 to convert source files 104 into output files 106 formatted according to the second file format.

Different file converters 110 can be configured to convert files of different corresponding source file formats into the target file format. As a non-limiting example, if the target file format is the Parquet file format, file converter 110A may convert JSON files into Parquet files, while file converter 110B may convert CSV files into Parquet files. Although JSON files may use AVPs to express information about records and CSV files may use rows and columns to express the same or similar types of information about records, the conversion engine 102 can use file converter 110A and file converter 110B to respectively convert JSON files and CSV files into Parquet files. Accordingly, the Parquet files produced by file converter 110A and file converter 110B can be output files 106 that use the same format to express the same types of information that were previously expressed in different types of data elements and/or different formats in the JSON files and the CSV files.

In some examples, the file converters 110 can components of the conversion engine 102. In other examples, the file converters 110 can be separate programs or computing elements, but can be invoked by the conversion engine 102 to convert source files 104 of corresponding file formats into output files 106 formatted according to the target file format.

The conversion engine 102 can have a file processor 116 that is configured to identify individual source files 104 in the source directory 108, and is configured to determine the source file formats of the individual source files 104. For example, the file processor 116 can use a file extension, metadata, and/or other information associated with a source file to determine the source file format of the source file. The file processor 116 can also determine which of the file converters 110 is configured to convert files of that source file format into the target file format indicated by the configuration data 114, and automatically invoke that file converter to convert the source file into an output file that is formatted according to the target file format.

As a non-limiting example, the file processor 116 can determine that source file 104A, shown in FIG. 1, is one of the source files 104 in the source directory 108. The file processor 116 can use a file extension and/or metadata associated with source file 104A to determine that source file 104A is an XML file. Based on determining that source file 104A is an XML file, and an indication in the configuration data 114 that the target file format is the Parquet file format, the file processor 116 can identify a particular file converter, of the file converters 110, that is configured to convert XML files into Parquet files. Accordingly, the file processor 116 can invoke the particular file converter to convert source file 104A into output file 106A, as shown in FIG. 1. Although the source file 104A was an XML file, the corresponding output file 106A can be formatted as a Parquet file in this example. The conversion engine 102 and/or the particular file converter can store the generated output file 106A in the destination directory 112.

The file processor 116 can determine file converters 110 that correspond to the source file formats of multiple source files 104 in the source directory 108, and invoke those file converters 110 to convert the source files 104 into output files 106 that are formatted according to the target file format. Accordingly, if the source directory 108 contains source files 104 formatted according to multiple source file formats, the file processor 116 can invoke multiple different file converters 110 associated with those source file formats, such that source files 104 of one or more source file formats are converted into output files 106 of the same target file format.

If the file processor 116 determines that the source file format of a source file in the source directory 108 matches the target file format, the file processor 116 can determine that the source file is already formatted according to the target file format. The file processor 116 can accordingly skip invoking a file converter, and can instead move or copy the source file into the destination directory 112 as an output file. For example, if the source directory 108 contains a Parquet file, and the target file format is the Parquet file format, the conversion engine 102 can move or copy the Parquet file from the source directory 108 into the destination directory 112 without performing any file format conversion operations. However, if the source directory 108 contains one or more source files 104 of other file formats, the file processor 116 can invoke one or more corresponding file converters 110 to convert those other source files 104 into Parquet files, and store the converted Parquet files in the destination directory 112.

In some examples, the conversion engine 102 can use the file converters 110 to convert the original source files 104 in the source directory 108 into output files 106 stored in the destination directory 112, and may then delete the original source files 104 from the source directory 108. In other examples, the conversion engine 102 may access or copy the original source files 104 in the source directory 108, and use file converters 110 to convert the source files 104 into output files 106 stored in the destination directory 112, but leave the original source files 104 in the source directory 108.

In some examples, the conversion engine 102 can include a conversion validator 118. The conversion validator 118 can be configured to process and evaluate output files 106, to determine whether output files 106 generated from source files 104 have the same number of records, values, and/or other elements as the original corresponding source files 104. For example, if a source file is a CSV file that includes data associated with five hundred records, the conversion validator 118 can verify that an output file in a target file format that was generated from the source CSV file also includes data associated with five hundred records.

In some examples, the conversion validator 118 can also use control files, metadata, and/or other types of information associated with source files 104 to validate corresponding converted output files 106. For example, if a source file is a .dat file produced by a mainframe, the mainframe may provide a corresponding control file that indicates how many records are reflected in the .dat file. Accordingly, rather than processing the .dat file to determine how many records are in the .dat file, the conversion validator 118 can use the separate control file provided by the mainframe to determine how many records are in the .dat file. The conversion validator 118 can thus verify whether an output file, of the target file format that is generated from the .dat file, also contains the number of records indicated by the control file.

The conversion validator 118 can also, in some examples, verify that the number of output files 106 produced by the conversion engine 102 and/or added to the destination directory 112 equals the number of source files 104 in the source directory 108. Accordingly, the conversion validator 118 can determine whether all of the source files 104 have been processed by the conversion engine 102, whether any source files 104 are still to be processed, or whether errors occurred that prevented the successful conversion of any of the source files 104.

In some examples, the conversion validator 118 and/or other elements of the conversion engine 102 may output user alerts and/or maintain one or more logs, such as error logs or logs of successful operations. For example, if output files 106 do not have the same number of values, and/or other elements as were present in corresponding source files 104 or that are indicated by separate control files, the conversion validator 118 may generate errors, output the errors to other systems or destinations, display the errors in a user interface associated with the conversion engine 102, and/or log the errors in an error log. Similarly, if the conversion validator 118 determines that the number of output files 106 in the destination directory 112 is not equal to the number of source files 104 in the source directory 108 after the conversion engine 102 has at least attempted to convert all of the source files 104, the conversion validator 118 may generate, output, display, and/or log an error indicating that not all of the source files 104 were successfully converted.

The conversion engine 102 can have a file splitter 120 that is configured to divide individual source files 104 into smaller component files that can be separately converted by file converters 110. In some examples, the conversion engine 102 may maintain an original source file in the source directory 108, but divide the original source file into a set of new smaller component files stored in the source directory 108 or another directory or memory location. The conversion engine 102 can also have a file assembler 122 configured to assemble converted component files into output files 106 that correspond to the individual source files 104 divided by the file splitter 120.

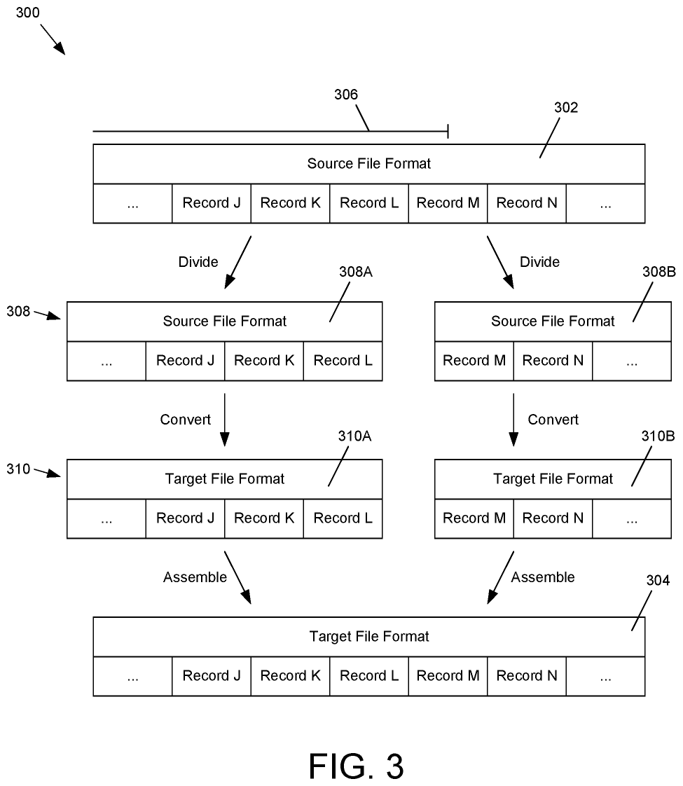

For example, a source file formatted according to a particular source file format can be divided into smaller component files that are also formatted according to that particular source file format. Each of the component files can be separately converted into a target file format indicated by the configuration data 114. The converted component files, formatted according to the target file format, can be assembled into an output file that is also formatted according to the target file format. For example, the file assembler 122 can stitch a set of converted component files that each include data associated with different records into a single output file that includes data associated with all of the records associated with the set of converted component files. An example of the file splitter 120 dividing a source file into component files, the component files being converted into converted component files, and the file assembler 122 assembling the converted component files into an output file is shown in FIG. 3, and is discussed further below with respect to that FIGURE.

The file splitter 120 can be configured to divide a source file if the size of the source file is larger than a file size threshold indicated by the configuration data 114. The file splitter 120 can divide the source file into smaller component files that may have sizes that are less than or equal to the file size threshold. The sizes of different component files may be equal or different.

As a non-limiting example, if the file size threshold is 3 GB, and source file 104A is over 3 GB in size, the file splitter 120 can divide source file 104A into component files that are each 3 GB or less in size. The file processor 116 can cause one or more instances of a file converter associated with the source file format of source file 104A to convert the component files into converted component files that are formatted according to the target file format indicated in the configuration data 114. The file assembler 122 can then assemble the converted component files into output file 106A, such that the output file 106A is formatted according to the target file format. Accordingly, although source file 104A is larger than the file size threshold in this example, smaller component files generated by dividing source file 104A can be converted into the target file format separately, and the converted component files can be assembled into the output file 106A.

In some examples, the file splitter 120 can analyze a source file, and divide the source file into component files such that individual records or other data elements in the source file are not divided or separated into different component files. For example, if a 4 GB file is to be divided into two component files, but data stored via bits located directly before and after the halfway point in the file are associated with the same record, the file splitter 120 may be configured to keep bits associated with the same record together in the same component file by dividing the file into component files at a position that is before or after those bits. Accordingly, one of these two component files may be larger than the other component file, as one may have more bits than the other. An example of dividing a source file into component files at a division point to avoid separating data associated with a record into different component files is discussed further below with respect to FIG. 3.

In some situations, it may be faster and/or take fewer computing resources to separately convert smaller component files divided from a large source file and then assemble the converted component files, relative to converting the entire large source file. For example, although a particular file converter may in some cases experience errors and/or slowdowns when converting a file that is larger than the file size threshold, such errors and/or slowdowns may be less likely to occur if the same particular file converter converts a file that is smaller than the file size threshold.

In some examples, the conversion engine 102 can use parallel processing and/or execute on different computing devices to convert different component files divided from a source file substantially concurrently, which may further reduce the time to convert the entire source file. For example, the conversion engine 102 can execute different instances of the same file converter in parallel at the same time, or substantially the same time, to convert separate component files that have been divided from the same source file, instead of using the same instance of a file converter to convert the separate component files in sequence.

When the file assembler 122 assembles a set of converted component files, generated from component files that were divided from a source file, into an output file, the conversion validator 118 may verify that the output file has the same information as the source file. Accordingly, the conversion validator 118 can verify that information from the source file was not lost during the division of the source file into the component files, the conversion of the component files into the converted component files, and the assembly of the converted component files into the output file. For example, the conversion validator 118 may verify that the output file contains the same number of records, or other types of data elements, as the source file. If the conversion validator 118 determines that the output file does not have the same information as the source file, the conversion validator 118 may generate, output, display, and/or log a corresponding error.

The conversion engine 102 can also have a conversion notifier 124. The conversion notifier 124 can be configured to generate and/or send a notification 126 to one or more destinations. The notification 126 can indicate that conversion operations associated with a set of source files 104 is complete, indicate any errors that occurred during such conversion operations, indicate status information associated with the conversion operations, and/or express any other information associated with the conversion operations.

The notification 126 can be an email, a text message, an alert displayed via a user interface, and/or any other type of message. In some examples, the configuration data 114 can include an email address, a phone number, and/or other identifier of a destination for the notification 126.

The notification 126 can include a preview of records or other data expressed in the output files 106 converted from the source files 104. For example, if the output files 106 include rows associated with a set of records, the conversion notifier 124 may extract a subset of the rows and include the subset of the rows in the notification 126. Accordingly, a user who views the notification 126 can see what types of data are expressed in the output files 106.

However, in some examples, the conversion notifier 124 can be configured to omit such a preview from the notification 126 if the configuration data 114 indicates that the source files 104 contained, or were likely to contain, sensitive data. For instance, if the configuration data 114 indicate that records in the source files 104 contain PII or other sensitive data, the conversion notifier 124 can omit a preview of the records from the notification 126, to avoid exposing the PII or other sensitive data in the notification 126.

Overall, the conversion engine 102 can process a set of source files 104 in the source directory 108 by determining the source file format of each source file, and automatically invoking file converters 110 associated with those source file formats to convert the individual source files 104 into corresponding output files 106 that are formatted according to the same target file format. By converting the individual source files 104 into corresponding output files 106 of the same target file format, the output files 106 can be stored, analyzed, and/or otherwise processed based on the same target file format. As an example, the output files 106 can be processed by analytics tools in the same way, for instance by sorting or partitioning data in the output files 106 by identification numbers or any other type of data or field common to multiple individual records within the output files 106, because all of the output files 106 can be in the same target file format.

The conversion engine 102 may continue searching for and/or converting source files 104 until all of the source files 104 in the source directory 108 have been converted. In some examples, the conversion engine 102 can be configured to continuously or periodically monitor the source directory 108 for new source files 104 added to the source directory 108 by one or more source applications or other providers, and convert such newly added source files 104 into corresponding output files 106 when the new source files 104 are discovered. In some examples, the conversion validator 118 can be configured to validate the conversion of each individual source file, and/or validate that the destination directory 112 holds number of output files 106 that is equal to the number of source files 104 in the source directory 108, after the conversion engine 102 has at least attempted to convert all of the source files 104 in the source directory 108.

As discussed above, for an individual source file, the file processor 116 of the conversion engine 102 can automatically determine the source file format of the source file, and automatically identify which of the file converters 110 is configured to convert that source file format into the target file format. The conversion engine 102 can automatically invoke the identified file converter to convert the source file into an output file, for example as discussed below with respect to FIG. 2.

FIG. 2 shows an example 200 of a conversion of a source file 202 into an output file 204. The file processor 116 of the conversion engine 102 can use a file extension, metadata, or other information to automatically identify the source file format of the source file 202. The file processor 116 can also determine the target file format, for the output file 204, indicated by the configuration data 114. The file processor 116 can identify which of the file converters 110 is configured to convert the source file format of the source file 202 into the target file format, and automatically invoke the identified file converter to convert the source file 202 into the output file 204.

The source file format of the source file 202 can be different than the target file format for the output file 204. However, the file converter can be configured to generate the output file 204 such that the output file 204 expresses the same records and/or other data elements as the source file 202. For example, the source file 202 may be a JSON file or other type of file that expresses information associated with different records using AVPs. However, the target file format for the output file 204 can be a table-based format that expresses information associated with different records using rows and columns instead of AVPs. Accordingly, the selected file converter can convert information about records expressed using AVPs in the source file 202 into corresponding row and columns of a table used by the target file format for the output file 204 as shown in FIG. 2. As discussed above, the conversion validator 118 may process the output file 204 to confirm that the output file 204 contains the same number of records as the source file 202.

In some examples, the size of a source file, such as source file 202, may exceed a file size threshold. In these examples, the file splitter 120 of the conversion engine 102 can divide the source file into multiple component files, as discussed below with respect to FIG. 3, such that the component files can be converted into converted component files and reassembled into an output file, such as output file 204.

FIG. 3 shows an example 300 in which a source file 302 can be divided, converted, and reassembled into an output file 304. The source file 302 can include information about a set of records, and can be formatted according to a particular source file format. As discussed above, the file processor 116 of the conversion engine 102 can identify which of the file converters 110 is configured to convert the source file format of the source file 302 into the target file format. However, the conversion engine 102 can also determine that the size of the source file exceeds a file size threshold 306. Based on determining that the size of the source file exceeds the file size threshold 306, the conversion engine 102 can use the file splitter 120 to divide the source file 302 into multiple component files 308, such as component file 308A and component file 308B. The component files 308 can continue to be formatted according to the source file format.

As shown in FIG. 3, dividing the source file 302 at a position that corresponds to the file size threshold 306 may in some cases result in data associated with a single record being separated into different component files 308. Accordingly, the file splitter 120 can be configured to determine one or more division points, at which the source file 302 is separated into component files 308, that avoid separating data associated with individual records into different component files 308, and that cause each of the component files 308 to have sizes that are less than the file size threshold 306. For example, rather than dividing the source file 302 at a position that corresponds to the file size threshold 306 and dividing record “M,” the file splitter 120 can instead divide the source file 302 at a position between record “L” and record “M” such that record “L” is in component file 308A and record “M” is in component file 308B.

The conversion engine 102 can use one or more instances of the identified file converter, corresponding to the source file format and the target file format, to individually convert each of the component files 308 into corresponding converted component files 310. For example, the file converter can convert component file 308A, formatted according to the source file format, into converted component file 310A that is formatted according to the target file format. Similarly, the same or a different instance of the file converter can convert component file 308B, formatted according to the source file format, into converted component file 310B that is formatted according to the target file format.

The file assembler 122 can assemble the converted component files 310, such as converted component file 310A and converted component file 310B, into the output file 304. Because the individual converted component files 310 were converted into the target file format, the output file 304 generated by combining the converted component files 310 can also be formatted according to the target file format.

As discussed above, dividing the source file 302 into the component files 308, separately converting the component files 308 into converted component files 310, and combining the converted component files 310 into the output file 304 may reduce the chances of a file converter experiencing errors, slowdowns, and/or other issues, relative to the file converter attempting to convert the original source file 302 that exceeds the file size threshold 306. Although FIG. 3 shows the source file 302 being divided into two component files 308, the file splitter 120 may divided the source file 302 into any larger number of smaller component files 308, such that the component files 308 can be separately converted into converted component files 310 that can be assembled into the output file 304.

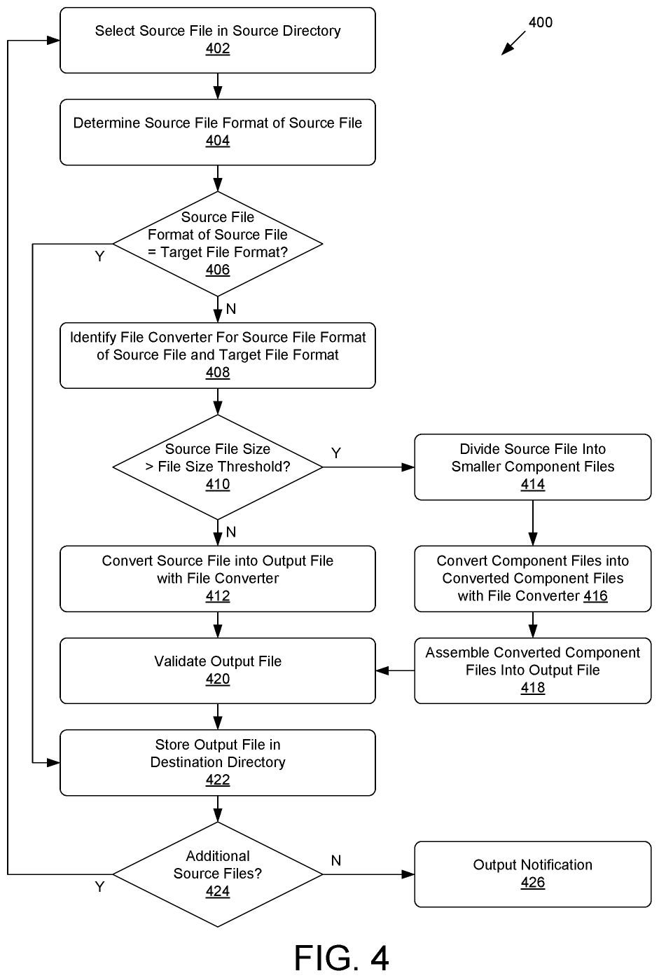

Although the examples shown in FIG. 2 and FIG. 3 related to converting a single source file into a single corresponding output file, the conversion engine 102 can automatically convert multiple source files 104 in the source directory 108 into output files 106. If different source files 104 in the source directory 108 have different source file formats, the conversion engine 102 can use different file converters 110 to convert the different source files 104 into output files 106 that have the same target file format. For example, although the source file 202 shown in FIG. 2 may be a JSON file, other source files 104 in the source directory 108 may have other file formats and can be converted by other file converters 110 into output files 106 of the target file format. Conversion of a set of source files 104 using one or more file converters 110 is discussed further below with respect to FIG. 4.

FIG. 4 shows a flowchart illustrating an example method 400 for converting source files 104 in the source directory 108 into output files 106 that are formatted according to a target file format. The method 300 shown in FIG. 4 can be performed by elements of the conversion engine 102 executing via one or more computing systems. An example system architecture for such a computing system is described below with respect to FIG. 5.

At block 402, the conversion engine 102 can select a source file in the source directory 108. The source directory 108 may hold multiple source files 104, and one or more elements of the conversion engine 102, such as the file processor 116, can access and/or scan the source directory 108 to select a particular source file in the source directory 108 at block 402. As described further below, the conversion engine 102 may iterate through the method 400 multiple times, such that the conversion engine 102 can select different source files 104 during different passes through block 402. For example, during different passes through block 402 the conversion engine 102 can select source files 104 in the source directory 108 at random, in sequential order, or using any other selection scheme.

At block 404, the conversion engine 102 can determine a source file format of the source file selected at block 402. For example, the file processor 116 of the conversion engine 102 can use a file extension of a file name of the source file, metadata associated with the source file, and/or other data associated with the source file to determine the source file format of the source file.

At block 406, the conversion engine 102 can determine whether the source file format of the source file determined at block 404 is the same as a target file format. The target file format can be indicated by the configuration data 114. For example, the configuration data 114 can indicate that the target file format is the Parquet file format, the CSV file format, the TSV file format, the JSON file format, the XML file format, or any other file format. If the source file format of the source file is the same as the target file format (Block 406—Yes), the conversion engine 102 can move or copy the source file into the destination directory 112 as an output file at block 422.

However, if the source file format of the source file is different than the target file format (Block 406—No), the conversion engine 102 can move to block 408. At block 408, the conversion engine 102 can identify a file converter, from among a set of file converters 110, that is configured to convert files of the source file format of the source file into files of the target file format.

At block 410, the conversion engine 102 can determine whether the size of the source file is greater than a file size threshold indicated by the configuration data 114. If the size of the source file is not greater than the file size threshold (Block 410—No), the conversion engine 102 can invoke the file converter identified at block 408 to convert the source file into an output file that is formatted according to the target file format at block 412. For example, the file converter can convert the source file, formatted according to the source file format, into a corresponding output file that is formatted according to the target file format.

However, if the size of the source file is greater than the file size threshold (Block 410—Yes), the conversion engine 102 can divide the source file into smaller component files at block 414. For example, the file splitter 120 of the conversion engine 102 can generate the component files such that the size of each component file is equal to or less than the file size threshold.

At block 416, the conversion engine 102 can invoke the file converter identified at block 408 to convert the component files, divided from the source file at block 412, into converted component files that are formatted according to the target file format. For example, the file converter can convert the individual component files, formatted according to the source file format, into corresponding converted component files that are formatted according to the target file format. At block 418, the conversion engine 102 can assemble the converted component files into an output file, for instance using the file assembler 122.

At block 420, the conversion engine 102 can validate the output file that was converted from the source file at block 412 or assembled from converted component files at block 418. In some examples, the conversion validator 118 of the conversion engine 102 can validate the output file by analyzing the source file to determine a number of records or other data elements in the source file, and determining whether the output file has the same number of records or other data elements. In other examples, if the source file is associated with a separate control file that already indicates the number of records or other data elements in the source file, the conversion validator 118 can validate the output file by determining whether the output file has the number of records or other data elements indicated in the control file. In some examples, if the conversion engine 102 is unable to validate the output file at block 420, for instance because the output file has a different number of records or other data elements than the source file, the conversion engine 102 can output and/or log a corresponding error associated with the source file and/or the output file.

At block 422, the conversion engine 102 can store the output file in the destination directory 112. At block 424, the conversion engine 102 can determine whether there are additional source files 104 in the source directory 108 that have not yet been processed by the conversion engine 102. If there are additional source files 104 in the source directory 108 (Block 424—Yes), the conversion engine 102 can return to block 402 to select another source file, and can repeat the steps shown in FIG. 4 for the newly selected source file.

However, if there are no more source files 104 in the source directory 108 that are yet to be processed by the conversion engine 102 (Block 424—No), the conversion engine 102 can determine that conversion operations associated with the source directory 108 are complete. In some examples, the conversion validator 118 may confirm that the conversion operations are complete by verifying that the number of output files 106 in the destination directory equals the number of source files 104 in the source directory. If the conversion validator 118 is unable to confirm that the conversion operations are complete, the conversion engine 102 can output and/or log a corresponding error, or attempt again at block 402 to select another source file.

Additionally, if the conversion operations are complete, the conversion engine 102 can also output a corresponding notification at block 426. For example, the conversion engine 102 can send the notification 126 to one or more destinations indicated in the configuration data 114 and/or display the notification 126 via a user interface, to notify one or more users that the conversion operations are complete. The notification 126 may indicate logged errors, if any, that occurred during the method 400. In some examples, the notification 126 can include a preview of a subset of records extracted from the output files, unless the configuration data 114 indicates that the source files 104 contained or were likely to contain sensitive information.

FIG. 5 shows an example system architecture 500 for a computing system 502 that can execute one or more elements of the conversion engine 102 described herein. The computing system 502 can include one or more servers, computers, computing systems, or other types of computing devices that execute one or more portions of the conversion engine 102, such as the file converters 110, the file processor 116, the conversion validator 118, the file splitter 120, the file assembler 122, and/or the conversion notifier 124. Individual computing devices of the computing system 502 may have the system architecture 500 shown in FIG. 5, or a similar system architecture.

In some examples, elements of the conversion engine 102 can be distributed among, and/or be executed by, multiple computing devices similar to the computing device shown in FIG. 5. For example, the file converters 110 may execute on one or more different computing devices than the file processor 116. Additionally, in some examples, different instances of one or more elements of the conversion engine 102 can be executed by different computing devices, and/or by the same computing device via multithreading or other parallel processing techniques. In some examples, one or more elements of the conversion engine 102 can be executed by one or more elements of a cloud computing environment or other distributed system, such as a cloud computing environment that hosts and/or executes one or more elements associated with the conversion engine 102, instances of the file converters 110, and/or other elements described herein.

The computing system 502 can include memory 504. In various examples, the memory 504 can include system memory, which may be volatile (such as RAM), non-volatile (such as ROM, flash memory, etc.) or some combination of the two. The memory 504 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing system 502 associated with the conversion engine 102. Any such non-transitory computer-readable media may be part of the computing system 502.

The memory 504 can store modules and data. The modules and data can include data and/or software or firmware elements, such as data and/or computer-readable instructions that are executable by one or more processors 508. For example, the memory 504 can store computer-executable instructions and data associated with the conversion engine 102, such as data and/or computer-executable instructions associated with one or more of the file converters 110, the configuration data 114, the file processor 116, the conversion validator 118, the file splitter 120, the file assembler 122, the conversion notifier 124, and/or other elements described herein. The memory 504 can also store other modules and data 506, such as any other modules and/or data that can be utilized by the computing system 502 to perform or enable performing any action taken by the computing system 502. Such other modules and data 506 can include a platform, operating system, and applications, and data utilized by the platform, operating system, and applications.

The computing system 502 can also have processor(s) 508, communication interfaces 510, a display 512, output devices 514, input devices 516, and/or a drive unit 518 including a machine readable medium 520.

In various examples, the processor(s) 508 can be a central processing unit (CPU), a graphics processing unit (GPU), both a CPU and a GPU, or any other type of processing unit. Each of the one or more processor(s) 508 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 508 may also be responsible for executing computer applications stored in the memory 504, which can be associated with common types of volatile (RAM) and/or nonvolatile (ROM) memory.

The communication interfaces 510 can include transceivers, modems, interfaces, antennas, telephone connections, and/or other components that can transmit and/or receive data over networks, telephone lines, or other connections. In some examples, the communication interfaces 510 can be used by the conversion engine 102 to locate and/or retrieve source files 104 in the source directory 108, transfer output files 106 to the destination directory 112, transmit notifications such as notification 126, or otherwise send and/or receive data.

The display 512 can be a liquid crystal display, or any other type of display commonly used in computing devices. For example, a display 512 may be a touch-sensitive display screen, and can then also act as an input device or keypad, such as for providing a soft-key keyboard, navigation buttons, or any other type of input.

The output devices 514 can include any sort of output devices known in the art, such as the display 512, speakers, a vibrating mechanism, and/or a tactile feedback mechanism. Output devices 514 can also include ports for one or more peripheral devices, such as headphones, peripheral speakers, and/or a peripheral display.

The input devices 516 can include any sort of input devices known in the art. For example, input devices 516 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 520 can store one or more sets of instructions, such as software or firmware, that embodies any one or more of the methodologies or functions described herein. The instructions can also reside, completely or at least partially, within the memory 504, processor(s) 508, and/or communication interface(s) 510 during execution thereof by the computing system 502. The memory 504 and the processor(s) 508 also can constitute machine readable media 520.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method, comprising:
determining, by at least one processor, one or more source file formats of source files in a source directory;
identifying, by the at least one processor, one or more file converters configured to convert files of the one or more source file formats into a target file format;
converting, by the at least one processor, and using the one or more file converters, the source files into corresponding output files that are formatted according to the target file format; and
storing, by the at least one processor, the corresponding output files in a destination directory.

2. The computer-implemented method of claim 1, wherein converting a particular source file into a corresponding output file comprises:
determining, by the at least one processor, that a size of the particular source file exceeds a file size threshold;
dividing, by the at least one processor, the particular source file into component files that have sizes less than or equal to the file size threshold;
converting, by the at least one processor, and using a file converter associated with a source file format of the particular source file, the component files into converted component files formatted according to the target file format; and
assembling, by the at least one processor, the converted component files into the corresponding output file.

3. The computer-implemented method of claim 2, wherein the at least one processor converts different component files substantially simultaneously via parallel processing.

4. The computer-implemented method of claim 1, wherein the at least one processor converts different source files substantially simultaneously via parallel processing.

5. The computer-implemented method of claim 1, wherein the at least one processor comprises different processors of different computing devices, and the different processors of different computing devices convert different source files substantially simultaneously.

6. The computer-implemented method of claim 1, further comprising validating, by the at least one processor, an output file that corresponds to a particular source file, wherein validating the output file includes determining that the output file and the particular source file contain a same number of records.

7. The computer-implemented method of claim 6, wherein the particular source file is a mainframe file, and the at least one processor determines a number of records in the particular source file based on a control file associated with the mainframe file.

8. The computer-implemented method of claim 1, further comprising:
determining, by the at least one processor, that all of the source files in the source directory have been converted into the corresponding output files in the destination directory; and
sending, by the at least one processor, a notification to at least one destination, the notification indicating that conversion operations associated with the source directory are complete.

9. The computer-implemented method of claim 8, wherein the notification includes at least one of:
an indication that the conversion operations are complete,
at least a portion of an error log identifying errors that occurred during conversion of the source files into the corresponding output files, or
a preview of records in the corresponding output files.

10. The computer-implemented method of claim 9, wherein the at least one processor omits the preview of the records from the notification based on configuration data indicating that the source files contain sensitive data.

11. One or more computing devices, comprising:
at least one processor;
memory storing computer-executable instructions associated with a conversion engine that, when executed by the at least one processor, cause the at least one processor to perform operations comprising:
identifying, based on configuration data:
a source directory;
a destination directory; and
a target file format;
determining one or more source file formats of source files in the source directory;
identifying one or more file converters configured to convert files of the one or more source file formats into the target file format;
converting, using the one or more file converters, the source files into corresponding output files formatted according to the target file format; and
storing the corresponding output files in the destination directory.

12. The one or more computing devices of claim 11, wherein the configuration data indicates a file size threshold, and the operations further comprise:
identifying one or more large source files in the source directory that have sizes that exceed the file size threshold;
converting the one or more large source files by individually dividing the one or more large source files into component files that have sizes less than or equal to the file size threshold;
converting, using the one or more file converters associated with source file formats of the one or more large source files, the component files into converted component files formatted according to the target file format; and
assembling the converted component files into one or more large output files that correspond to the one or more large source files.

13. The one or more computing devices of claim 11, wherein the operations further comprise validating an output file that corresponds to a particular source file, by determining that the output file and the particular source file contain a same number of records.

14. The one or more computing devices of claim 11, wherein the configuration data indicates a destination for a notification, wherein the operations further comprise sending the notification to the destination upon completion of conversion of the source files into the corresponding output files.

15. The one or more computing devices of claim 14, wherein the operations further comprise:
including, in the notification, a preview of records in the corresponding output files based on a first indication in the configuration data that the source files include sensitive data, or
omitting, from the notification, the preview of the records based on a second indication in the configuration data that the source files do not include sensitive data.

16. One or more non-transitory computer-readable media storing computer-executable instructions that, when executed by at least one processor, cause the at least one processor to perform operations comprising:
identifying, based on configuration data:
a source directory;
a destination directory; and
a target file format;
determining one or more source file formats of source files in the source directory;
identifying one or more file converters configured to convert files of the one or more source file formats into the target file format;
converting, using the one or more file converters, the source files into corresponding output files formatted according to the target file format; and
storing the corresponding output files in the destination directory.

17. The one or more non-transitory computer-readable media of claim 16, wherein the configuration data indicates a file size threshold, and the operations further comprise:
identifying one or more large source files in the source directory that have sizes that exceed the file size threshold;
converting the one or more large source files by individually dividing the one or more large source files into component files that have sizes less than or equal to the file size threshold;
converting, using the one or more file converters associated with source file formats of the one or more large source files, the component files into converted component files formatted according to the target file format; and
assembling the converted component files into one or more large output files that correspond to the one or more large source files.

18. The one or more non-transitory computer-readable media of claim 16, wherein the operations further comprise validating an output file that corresponds to a particular source file, by determining that the output file and the particular source file contain a same number of records.

19. The one or more non-transitory computer-readable media of claim 16, wherein the configuration data indicates a destination for a notification, wherein the operations further comprise sending the notification to the destination upon completion of conversion of the source files into the corresponding output files.

20. The one or more non-transitory computer-readable media of claim 19, wherein the operations further comprise:
including, in the notification, a preview of records in the corresponding output files based on a first indication in the configuration data that the source files include sensitive data, or
omitting, from the notification, the preview of the records based on a second indication in the configuration data that the source files do not include sensitive data.

21. A computing system, comprising:
selection means for selecting source files in a source directory;
identification means for identifying source file formats of the source files;
conversion means for converting the source files from the source file formats into corresponding output files of a target file format; and
storage means for storing the corresponding output files in a destination directory.

22. The computing system of claim 21, wherein the conversion means comprises means for:
dividing large source files, of the source files, that exceed a file size threshold into smaller component files that have sizes less than or equal to the file size threshold;
converting the smaller component files into converted component files of the target file format; and
assembling the converted component files into output files that correspond to the large source files.

23. The computing system of claim 21, further comprising validation means for validating that the source files and the corresponding output files contain a same number of records.

24. The computing system of claim 21, further comprising notification means for sending a notification to at least one destination, the notification including at least one of:
an indication that conversions of the source files into the corresponding output files are complete,
at least a portion of an error log identifying errors that occurred during conversion of the source files into the corresponding output files, or
a preview of records in the corresponding output files.
